(19) United States
(12) Patent Application Publication
(10) Pub. No.: US 2023/0191824 A1
(43) Pub. Date: Jun. 22, 2023

(54) POROUS POLYMER SECURITY FEATURE

(71) Applicant: Spectra Systems Corporation, Providence, RI (US)

(72) Inventor: Nabil Lawandy, Saunderstown, RI (US)

(21) Appl. No.: 18/082,683

(22) Filed: Dec. 16, 2022

Related U.S. Application Data
(63) Continuation-in-part of application No. 17/553,422, filed on Dec. 16, 2021.

(51) Int. Cl. B42D 25/36; B32B 27/32

(52) U.S. Cl. CPC B42D 25/36; B32B 27/322; B42D 25/29

(57) ABSTRACT

A system and associated method, the system including an item including a porous polymer layer including a polymer material capable of absorbing a liquid, the polymer material having an index of refraction that is the same or substantially the same as an index of refraction of the liquid, and a substrate layer, where the porous polymer layer is disposed on the substrate layer, and a liquid source comprising the liquid, where the porous polymer layer appears transparent in response to absorption of the liquid from the liquid source by the porous polymer layer.

### CROSS-REFERENCE TO RELATED APPLICATIONS

The present application is a continuation-in-part application of U.S. non-provisional application Ser. No. 17/553,422, filed Dec. 16, 2021, the disclosure of which is incorporated herein by reference in its entirety.

### TECHNICAL FIELD

The present invention relates generally to systems and methods utilizing a porous polymer security feature for authentication and anti-counterfeiting applications. More specifically, the present invention relates to a porous polymer security feature having an index of refraction that is the same or substantially similar to that of a liquid to be absorbed by the feature where, upon absorption and non-evaporation, the feature is rendered transparent and capable of revealing underlying printing or material.

### BACKGROUND OF THE INVENTION

The inception of the first polymer-based banknotes in Australia in 1988 provided a new perspective to global economic security. The polymer banknote material, named GUARDIAN, was developed jointly by the Reserve Bank of Australia, Commonwealth Scientific and Industrial Research Organization (CSIRO), and the University of Melbourne. Besides GUARDIAN as a commonly-used material, other types of polymer banknotes have been developed, namely TYVEK by DuPont and American Bank Note Company in the 1980's and DURANOTES by Canada's AGRA and US Mobil Chemical. At the present time, there are at least 30 different denominations totaling greater than 3 billion polymer-based banknotes that are currently circulating in approximately 30 countries, which accounts for about 15% of the countries in the world.

Counterfeiting is one of the top concerns regarding banknotes. United States currency is known to be vulnerable to counterfeiting because the design was created in the 1920's and constitutes an international currency valued globally. With rapid improvement in printing technology, including high resolution scanners and printers, there has been a growing number of counterfeiting concerns. In 1995 alone, over 360 million counterfeit banknotes were confiscated, with an estimate that more than a billion dollars in counterfeit money went undetected.

Polymer banknotes have provided a strong deterrent to counterfeiters in many countries. For example, since the introduction of the 20-Mexican peso polymer banknotes in 2002, Mexico has seen a dramatic decrease of the number of detected counterfeit 20-peso banknotes by 96% in the following years. However, the current cost of polymer banknote manufacturing is higher than that of paper banknotes. Ultimately, though, effective and inexpensive counterfeiting techniques for polymer materials are needed.

Security, durability, and printability are the three technical criteria for Central Banks to purchase banknote materials. Security requires that the features be difficult to counterfeit yet simple enough for the general public to recognize. The decision to convert from paper banknotes to polymer banknotes may be based on factors including degree of difficulty in counterfeiting, robustness for long-term use, and printing costs. In the case of the United States, at least 1,700 billion U.S. dollar bills are circulating in the world. The cost of printing a paper banknote is approximately $0.04, and the circulation time for such paper banknotes is only about 18 months on average, which is much less than the 4-year circulation time for polymer banknotes. The estimated potential impact of transforming all current paper U.S. banknotes into polymer banknotes is from $0.68 billion to $68 billion. Accordingly, there is significant interest in developing advanced anti-counterfeiting features specifically for polymer banknotes.

In light of the unique material properties and manufacturing techniques of polymer thin films, new security features have been introduced into the polymer banknotes that were not available or possible in paper banknotes. For instance, GUARDIAN banknotes employ optical transparent windows with embossed microscale features incorporated within the polymer substrate. Two-dimensional optical devices, in the form of diffraction gratings, iridescent bands, and shadow images, can also be introduced into the optically transparent window through embossing techniques. While the introduction of these new anti-counterfeiting features into polymer banknotes has greatly increased currency security, further anti-counterfeiting mechanisms suitable for polymer substrates are required.

### SUMMARY OF THE INVENTION

In general, in one aspect, the invention features a system including an item including a porous polymer layer including a polymer material capable of absorbing a liquid, the polymer material having an index of refraction that is the same or substantially the same as an index of refraction of the liquid, and a substrate layer, where the porous polymer layer is disposed on the substrate layer, and a liquid source including the liquid, where the porous polymer layer appears transparent in response to absorption of the liquid from the liquid source by the porous polymer layer.

Implementations of the invention may include one or more of the following features. The polymer material may be polytetrafluoroethylene. The liquid may be water or an alcohol. The substrate may include printing thereon such that the printing is visible upon or after absorption of the liquid by the porous polymer layer. The printing may be configured as a QR code. The substrate may include a hologram or a foil thereon such that the hologram or the foil is visible upon or after absorption of the liquid by the porous polymer layer. The substrate may include an ultraviolet radiation-activated element therein or thereon such that ultraviolet radiation-activated element may be activated upon or after absorption of the liquid by the porous polymer layer. The liquid may evaporate from the porous polymer layer after absorption of the liquid by the porous polymer layer without structurally changing the porous polymer layer. The item may be a banknote, a tax stamp, a credit card, a bank card, a license, or an identification document. The liquid source may be configured as a pen or a magic marker capable of retaining and eliminating the liquid.

In general, in another aspect, the invention features a method including providing an item including a porous polymer layer including a polymer material capable of absorbing a liquid, the polymer material having an index of refraction that is the same or substantially the same as an index of refraction of the liquid, and a substrate layer, where the porous polymer layer is disposed on the substrate layer, and depositing the liquid from a liquid source onto the porous polymer layer, where the porous polymer layer appears transparent in response to absorption of the liquid from the liquid source by the porous polymer layer.

Implementations of the invention may include one or more of the following features. The polymer material may be polytetrafluoroethylene. The liquid may be water or an alcohol. The substrate may include printing thereon such that the printing is visible upon or after absorption of the liquid by the porous polymer layer. The printing may be configured as a QR code. The substrate may include a hologram or a foil thereon such that the hologram or the foil is visible upon or after absorption of the liquid by the porous polymer layer. The substrate may include an ultraviolet radiation-activated element therein or thereon such that ultraviolet radiation-activated element may be activated upon or after absorption of the liquid by the porous polymer layer. The liquid may evaporate from the porous polymer layer after absorption of the liquid by the porous polymer layer without structurally changing the porous polymer layer. The item may be a banknote, a tax stamp, a credit card, a bank card, a license, or an identification document. The liquid source may be configured as a pen or a magic marker capable of retaining and eliminating the liquid.

### BRIEF DESCRIPTION OF THE FIGURES

FIG. 1A is a photograph depicting a porous polymer security feature according to one embodiment of the present invention, in which the security feature is utilized in connection with a banknote where the security feature is not presently absorbing a liquid;

FIG. 1B is a photograph depicting the porous polymer security feature of FIG. 1A where the security feature is absorbing a liquid;

FIG. 2A is a photograph depicting a porous polymer security feature according to another embodiment of the present invention, in which the security feature is utilized in connection with a banknote where the security feature is not presently absorbing a liquid;

FIG. 2B is a photograph depicting the porous polymer security feature of FIG. 2A where the security feature is absorbing a liquid; and

FIG. 2C is a photograph depicting the porous polymer security feature of FIG. 2A where the security feature is partially absorbing a liquid.

### DETAILED DESCRIPTION OF THE PREFERRED EMBODIMENTS

The present invention provides for systems and methods utilizing a porous polymer security feature, e.g., for authentication and anti-counterfeiting applications. A porous polymer security feature of the present invention may have an index of refraction that is the same or substantially similar to that of a liquid to be absorbed by the feature where, upon absorption and non-evaporation, the feature is rendered transparent and capable of revealing underlying text or material.

The porous polymer security feature may include a polymer material having an index of refraction equal to or approximately that of 1.3, which corresponds to an index of refraction of a liquid to be absorbed by the security feature (e.g., water or an alcohol). A non-limiting example of such a polymer material is polytetrafluoroethylene (PTFE) (n=1.38). A polymer material utilized in the present invention may be clear or transparent. The security feature may appear opaque or semi-opaque in the absence of any liquid being absorbed by the security feature, and may appear clear or transparent when liquid is absorbed by the security feature. The security feature may take any shape, geometric or otherwise, with non-limiting examples including square, rectangle, triangle, circle, oval, diamond, star, and the like.

In one embodiment of the present invention, prior to the disposition of the index-matching liquid on the porous polymer security feature, i.e., in the pores of the porous polymer security feature, the security feature appears opaque or substantially opaque. This opacity is the result of light passing through the porous polymer security feature refracting and scattering at each boundary between air in the pores and the polymer material (which has a higher index of refraction, e.g., 1.35, than that of air). When the index-matching liquid is placed on the porous polymer security feature and said liquid taken in or absorbed by the pores of the porous polymer security feature, those portions of the security feature in which the pores are filled with the index-matching liquid have an index of refraction close to or matching that of the polymer material (e.g., the index of refraction of water is 1.33), and thus have a higher clarity or transparency due to less refracting and scattering of light passing through the substrate and at the boundaries between the liquid-filled pores and the polymer material. Consequently, the security feature returns to its initial opacity as the index-matching liquid is drawn away from the pores of the porous polymer security feature, e.g., by evaporation or sublimation.

The porous polymer security feature may include a substrate as part of a multi-layer composite structure or be otherwise disposed on a substrate. In such embodiments, the porous polymer layer is disposed on top of a substrate. The substrate may include printing thereon and thus below the porous polymer layer, whereby such printing is seen by or revealed to a user when the porous polymer layer absorbs an appropriate liquid, due to the index-matching of the utilized polymer material and the liquid. In one example, the printing is in the form of a QR code. In this example, the QR code can only be scanned or read upon liquid absorption by the security feature. Similarly, the substrate may include holograms or foils thereon, such as those associated with banknotes/currency, that may be seen or revealed through the aforementioned liquid absorption. Additionally, the substrate may include an ultraviolet (UV) radiation-activated element therein or thereon, such as those associated with banknotes/currency, whereby directing a UV light source (e.g., a blacklight) at the security feature will only reveal the UV radiation-activated element when the security feature has absorbed the appropriate liquid. Accordingly, in the absence of liquid absorption by the security feature, directing the UV light source at the security feature will not result in the visible display of the UV radiation-activated element. Ultimately, at a minimum, due to the index-matching of the polymer material and the absorbed liquid, there is greater clarity to the porous polymer layer when the liquid is absorbed by the layer.

With the porous polymer security feature of the present invention, upon evaporation of the absorbed liquid, the security feature reverts to its original appearance. This means, for example, that any printing, holograms, foils, and the like disposed on an underlying substrate may no longer be visible to a user. In certain embodiments, the security feature may revert back to an opaque or semi-opaque state of appearance. Accordingly, this mechanism of revelation via liquid absorption, which may serve as an easily-effectuated authentication or anti-counterfeit measure, is reversible, repeatable, and does not structurally affect or change the security feature. This stands in contrast to other known anti-counterfeiting mechanisms, including those utilizing nanoscopic or microscopic reconfigurable pillars, that require or induce a structural change in the feature and leave the feature reconfigured after evaporation of an absorbed liquid.

The porous polymer security feature may be utilized in or as part of a label or may be attached or affixed to any product or item, e.g., banknotes/currency, other secure instruments, tax stamps, credit cards, bank cards, licenses, identification (ID) cards or documents, apparel, and consumer goods, for which authentication may be desirable. The porous polymer security feature is tamperproof by virtue of the associated liquid absorption authentication mechanism.

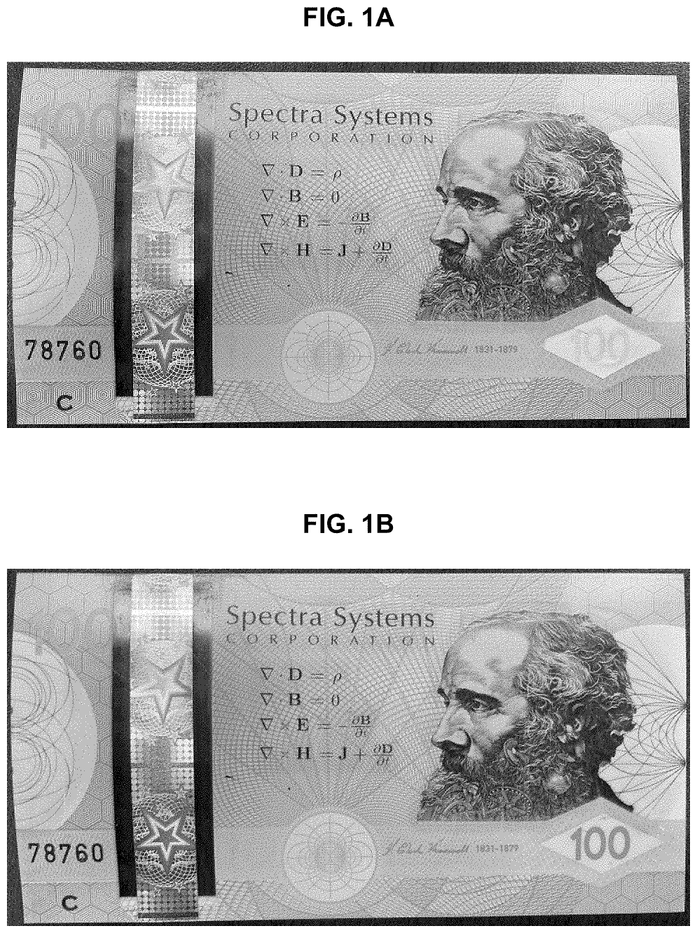

FIGS. 1A-1B depict a porous polymer security feature utilized in connection with a banknote. The porous polymer security feature is a diamond-shaped feature disposed on a bottom-right corner of the banknote. In FIG. 1A, when the porous polymer security feature is not absorbing an appropriate liquid (e.g., water), the security feature appears semi-opaque, as the underlying printing (“100”) is only partially visible. In FIG. 1B, when the porous polymer security feature is absorbing an appropriate liquid, the security feature appears clear or transparent, and the underlying printing can more clearly be seen, with the color and text stylization of the printing being visible.

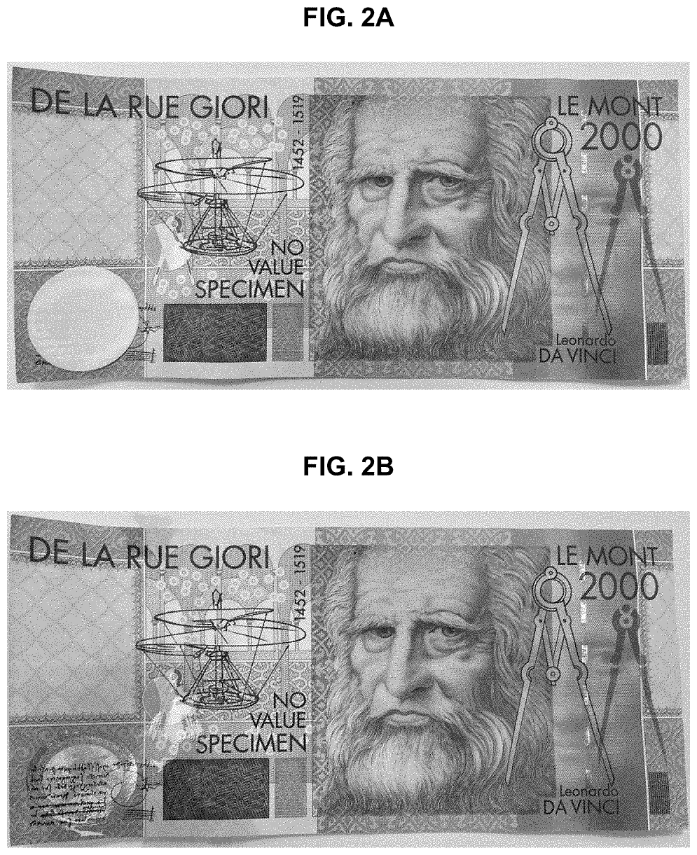

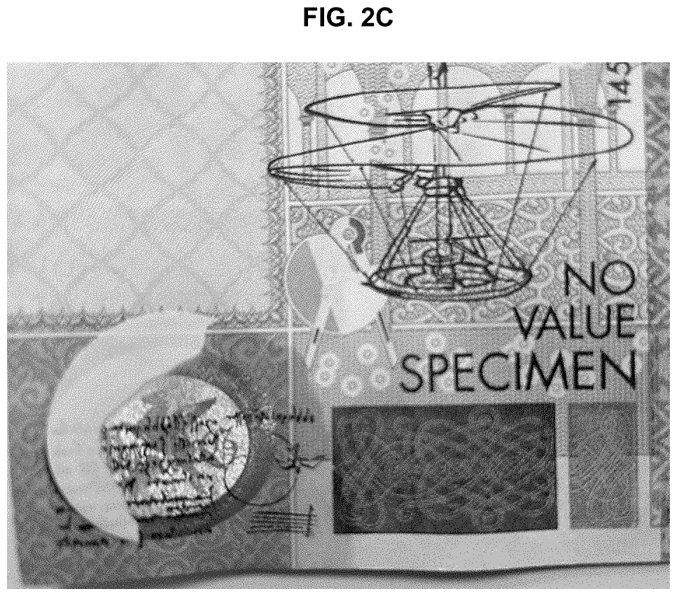

FIGS. 2A-2B depict another porous polymer security feature utilized in connection with a banknote. The porous polymer security feature is an oval-shaped feature disposed on a bottom-left corner of the banknote. In FIG. 2A, when the porous polymer security feature is not absorbing an appropriate liquid, the security feature appears semi-opaque, as the underlying material (printing and hologram) is only partially visible. In FIG. 2B, when the porous polymer security feature is absorbing an appropriate liquid, the security feature appears clear or transparent, and the underlying material can more clearly be seen, with the printed text as well as the hologram and its holographic effect being visible. In FIG. 2C, when only a portion of the porous polymer security feature is absorbing an appropriate liquid, this portion appears clear or transparent while the remainder of the security feature that has not absorbed any of the liquid appears semi-opaque.

In systems and methods utilizing a porous polymer security feature of the present invention, a pen or magic marker may also be included, such pen or magic marker containing the appropriate liquid to be absorbed by the porous polymer security feature. These devices permit easy depositing of the liquid onto the security feature. While a pen or magic marker are preferred examples, the present invention is not so limited and includes any device capable of retaining and eliminating an appropriate liquid.

The embodiments and examples above are illustrative, and many variations can be introduced to them without departing from the spirit of the disclosure or from the scope of the appended claims. For example, elements and/or features of different illustrative and exemplary embodiments herein may be combined with each other and/or substituted with each other within the scope of this disclosure. For a better understanding of the invention, its operating advantages and the specific objects attained by its uses, reference should be had to the accompanying drawings and descriptive matter in which there are illustrated exemplary embodiments of the invention.

What is claimed is:

1. A system comprising:
an item comprising:
a porous polymer layer comprising a polymer material capable of absorbing a liquid, the polymer material having an index of refraction that is the same or substantially the same as an index of refraction of the liquid; and
a substrate layer;
wherein the porous polymer layer is disposed on the substrate layer; and
a liquid source comprising the liquid;
wherein the porous polymer layer appears transparent in response to absorption of the liquid from the liquid source by the porous polymer layer.

2. The system of claim 1, wherein the polymer material is polytetrafluoroethylene.

3. The system of claim 1, wherein the liquid is water or an alcohol.

4. The system of claim 1, wherein the substrate includes printing thereon such that the printing is visible upon or after absorption of the liquid by the porous polymer layer.

5. The system of claim 4, wherein the printing is configured as a QR code.

6. The system of claim 1, wherein the substrate includes a hologram or a foil thereon such that the hologram or the foil is visible upon or after absorption of the liquid by the porous polymer layer.

7. The system of claim 1, wherein the substrate includes an ultraviolet radiation-activated element therein or thereon such that ultraviolet radiation-activated element may be activated upon or after absorption of the liquid by the porous polymer layer.

8. The system of claim 1, wherein the liquid may evaporate from the porous polymer layer after absorption of the liquid by the porous polymer layer without structurally changing the porous polymer layer.

9. The system of claim 1, wherein the item is a banknote, a tax stamp, a credit card, a bank card, a license, or an identification document.

10. The system of claim 1, wherein the liquid source is configured as a pen or a magic marker capable of retaining and eliminating the liquid.

11. A method comprising:
providing an item comprising a porous polymer layer comprising a polymer material capable of absorbing a liquid, the polymer material having an index of refraction that is the same or substantially the same as an index of refraction of the liquid, and a substrate layer, wherein the porous polymer layer is disposed on the substrate layer; and
depositing the liquid from a liquid source onto the porous polymer layer;
wherein the porous polymer layer appears transparent in response to absorption of the liquid from the liquid source by the porous polymer layer.

12. The method of claim 11, wherein the polymer material is polytetrafluoroethylene.

13. The method of claim 11, wherein the liquid is water or an alcohol.

14. The method of claim 11, wherein the substrate includes printing thereon such that the printing is visible upon or after absorption of the liquid by the porous polymer layer.

15. The method of claim 14, wherein the printing is configured as a QR code.

16. The method of claim 11, wherein the substrate includes a hologram or a foil thereon such that the hologram or the foil is visible upon or after absorption of the liquid by the porous polymer layer.

17. The method of claim 11, wherein the substrate includes an ultraviolet radiation-activated element therein or thereon such that ultraviolet radiation-activated element may be activated upon or after absorption of the liquid by the porous polymer layer.

18. The method of claim 11, wherein the liquid may evaporate from the porous polymer layer after absorption of the liquid by the porous polymer layer without structurally changing the porous polymer layer.

19. The method of claim 11, wherein the item is a banknote, a tax stamp, a credit card, a bank card, a license, or an identification document.

20. The method of claim 11, wherein the liquid source is configured as a pen or a magic marker capable of retaining and eliminating the liquid.
